(19) United States
(12) Patent Application Publication
(10) Pub. No.: US 2005/0276600 A1
(43) Pub. Date: Dec. 15, 2005

(54) Control structure and electronic device utilizing the same

(75) Inventor: Chi-Wen Chou, Xizhi City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/152,131

(22) Filed: Jun. 14, 2005

(30) Foreign Application Priority Data
Jun. 15, 2004 (TW) 93117176

(51) Int. Cl. G03B 17/00

(52) U.S. Cl. 396/543

(57) ABSTRACT

A control structure. A main body pivots on a corner of an electronic device. The main body has a contact portion, an arm extending in a first direction from one side of the contact portion, and a connecting portion connected to another side of the contact portion. A shaft in the electronic device is connected to the connecting portion. When the contact portion is pressed and rotates around the shaft, the arm contacts the switch.

### BACKGROUND

The invention relates to a control structure for an electronic device.

A conventional control structure is shown in FIG. 1. A control 10, disposed on an upper surface of a digital camera 100, can only be pressed from a direction perpendicular to the upper surface. However, in certain design consideration, the control may be designed on the corner. As shown in FIG. 2, a control 20 is disposed on a corner of the digital camera 100, although only a single angle of press-activation is still provided, representing inconvenience for the user.

### SUMMARY

A control structure of an embodiment of the invention for an electronic device including a housing and a switch comprises a main body positioned on a corner of the electronic device and a shaft disposed inside the housing and connected to the main body, wherein the main body is pressed to rotate around the shaft to activate the switch. The main body comprises a contact portion, an arm extending in a first direction from one side of the contact portion, and a connecting portion connected to another side of the contact portion.

An elastic member is further connected to the shaft abutting an inner side of the housing, wherein the rotated main body is returned by elastic force generated by the elastic member abutting the housing. The elastic member can be an elastic arm extending in a second direction, such as substantially perpendicular to the first direction.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional control disposed on an upper surface of a digital camera;

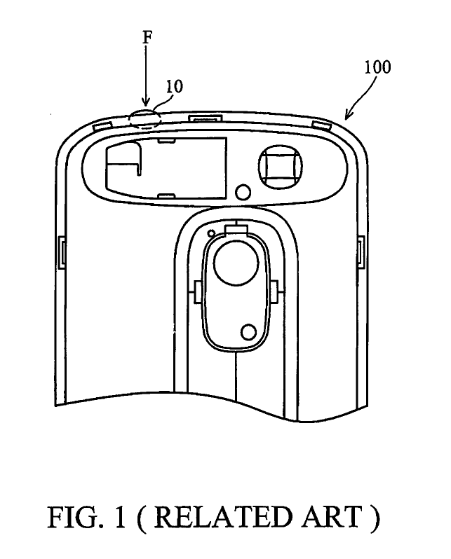

FIG. 2 is a schematic view of a conventional control disposed on a corner of a digital camera;

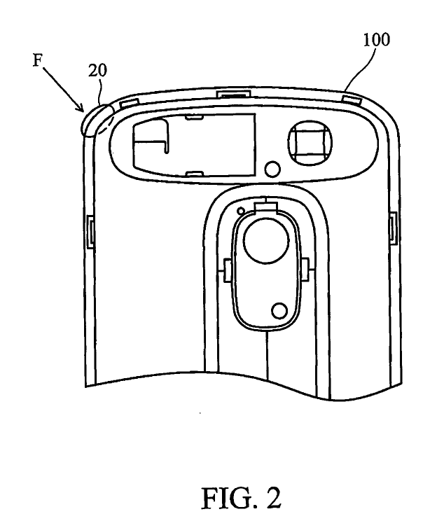

FIG. 3 is a schematic view of a control structure according to an embodiment of the invention;

FIG. 4 is a front view of a control structure according to an embodiment of the invention;

FIG. 5 is a front view of a control structure according to an embodiment of the invention with the control pressed; and

FIG. 6 is a perspective view of a control structure according to an embodiment of the invention.

### DETAILED DESCRIPTION

The control structure of an embodiment of the invention is applicable to various electronic devices, with the device disclosed here a digital camera.

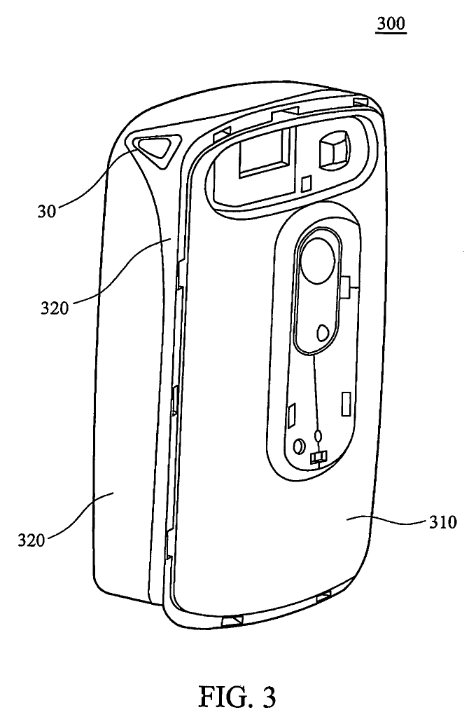

Referring to FIG. 3, a control is disposed on a corner of a digital camera 300. The digital camera 300 is provided with a front housing 310 and a back housing 320. The control comprises a main body 30 protruding from the back housing 320.

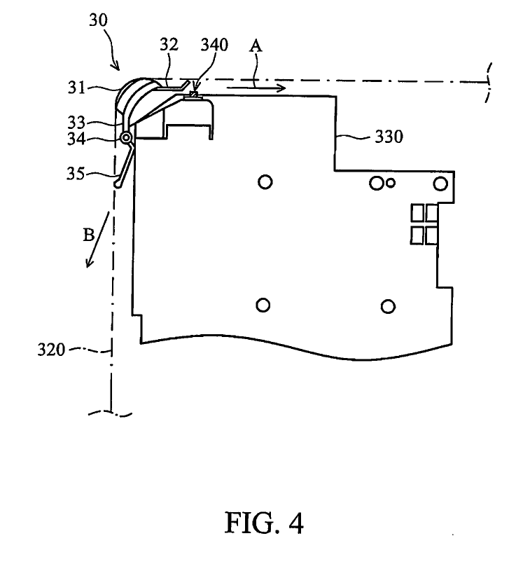

FIG. 4 shows a configuration of the control, comprising a main body 30 and a shaft 34 pivoting on the back housing 320. A circuit board 330 is disposed in the digital camera 300 (the back housing 320 is removed). A switch 340 is disposed on the circuit board 330 near the main body 30 for actuating a shutter of the digital camera 300. The main body 30, pivoted to an inner side of the back housing 320, comprises a contact portion 31 having a specific convex shape and protruding from the back housing 320, an arm 32 extending in a first direction A from one side of the contact portion 31 to activate the switch 340, and a connecting portion 33 connecting the contact portion 31 and the shaft 34. The control further comprises an elastic arm 35 connected to the shaft 34 and extending in a second direction B.

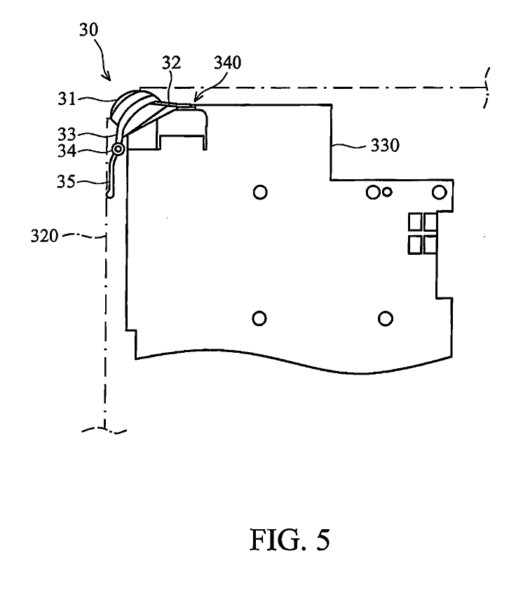

When depressed, the contact portion 31 rotates around the shaft 34 (clockwise) to impel the arm 32 to activate the switch 340. Elastic arm 35 also rotates around the shaft 34 simultaneously, biasing the back housing 320 to elastically deform as shown in FIG. 5. When the contact portion 31 is released, elastic force generated by the elastic arm 35 rotates the elastic arm 35 counterclockwise to return the contact portion 31 and the arm 32 to their original positions.

As an alternative to the elastic arm, a torsion spring can also be adapted to return the contact portion 31 and the arm 32, disposed on the shaft with one end abutting the inner side of the back housing 320. This causes the same result as the elastic arm.

In such a structure, torque is generated on the shaft 34 by the contact portion 31 in an arbitrary direction, thereby activating the switch 340.

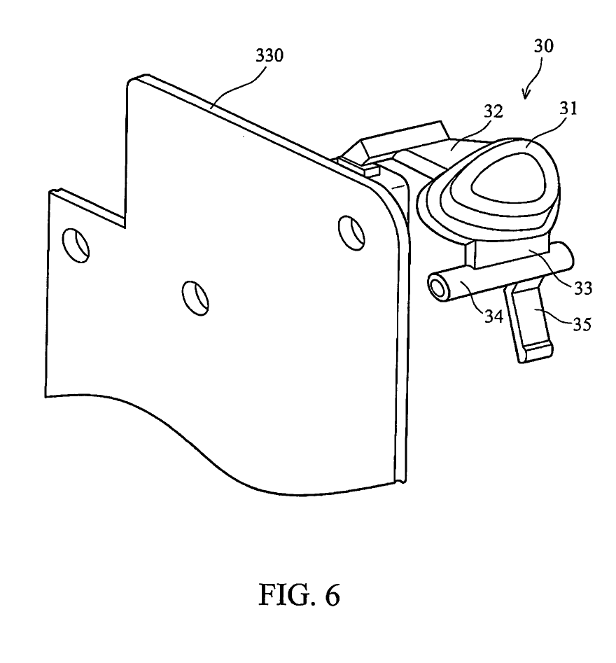

The contact portion 31 can have a specific convex shape for easier use. As shown in FIG. 6, the contact portion 31 is substantially hemispherical with many small planes thereon.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A control structure for an electronic device comprising a housing and a switch, comprising:
a main body on a corner of the electronic device; and
a shaft disposed inside the housing and connected to the main body;
wherein the main body, when depressed, rotates around the shaft to activate the switch.

2. The control structure as claimed in claim 1, wherein the main body comprises:
a contact portion;
an arm extending in a first direction from one side of the contact portion; and
a connecting portion connected to another side of the contact portion.

3. The control structure as claimed in claim 1 further comprising an elastic member connected to the shaft and abutting an inner side of the housing, wherein the rotated main body is returned by elastic force generated by the elastic member abutting the housing.

4. The control structure as claimed in claim 3, wherein the elastic member comprises an elastic arm extending in a second direction.

5. The control structure as claimed in claim 4, wherein the second direction is substantially perpendicular to the first direction.

6. The control structure as claimed in claim 3, wherein the elastic member comprises a torsion spring.

7. The control structure as claimed in claim 2, wherein the contact portion has a specific convex shape.

8. The control structure as claimed in claim 7, wherein the specific convex shape is substantially hemispherical.

9. An electronic device, comprising:
a housing;
a circuit board disposed inside the housing;
a switch disposed on the circuit board; and
a control disposed on a corner of the housing, comprising:
a shaft disposed inside the housing;
a contact portion protruding from the housing;
a connecting portion connecting the contact portion and the shaft; and
an arm extending in a first direction from one side of the contact portion;
wherein the contact portion, when pressed, rotates around the shaft to activate the switch.

10. The electronic device as claimed in claim 9, wherein the control further comprises an elastic member connected to the shaft and abutting an inner side of the housing, wherein the rotated main body is returned by elastic force generated by the elastic member abutting the housing.

11. The electronic device as claimed in claim 10, wherein the elastic member comprises an elastic arm extending in a second direction.

12. The electronic device as claimed in claim 11, wherein the second direction is substantially perpendicular to the first direction.

13. The electronic device as claimed in claim 10, wherein the elastic member comprises a torsion spring.

14. The electronic device as claimed in claim 9, wherein the contact portion has a specific convex shape.
